(19) United States
(12) Patent Application Publication
(10) Pub. No.: US 2017/0195778 A1
(43) Pub. Date: Jul. 6, 2017

(54) METHOD AND APPARATUS FOR BEING COMPATIBLE WITH FORWARD INSERTION AND INVERTED INSERTION OF ANALOG EARPHONE

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Qing ZHAO, Beijing (CN)

(21) Appl. No.: 15/240,140

(22) Filed: Aug. 18, 2016

Related U.S. Application Data
(63) Continuation of application No. PCT/CN2016/088776, filed on Jul. 6, 2016.

(30) Foreign Application Priority Data
Dec. 31, 2015 (CN) 2015110323155

(51) Int. Cl. H04R 1/10; H04R 3/00

(52) U.S. Cl. CPC H04R 1/1091; H04R 3/00; H04R 2420/09

(57) ABSTRACT

The present disclosure discloses a method and an apparatus for being compatible with forward insertion and inverted insertion of an analog earphone, wherein the method comprises: the two differential input interfaces of the CODEC chip are connected to the SBU1 and SBU2 pins of the TYPE C interface respectively, wherein the SBU1 and SBU2 pins are the two sideband using signal pins and the two differential input interfaces are two MIC input interfaces of CODEC chip.

### CROSS REFERENCE TO RELATED APPLICATIONS

The present application is a continuation of PCT application which has an application No. of PCT/CN2016/088776 and was filed on Jul. 6, 2016. This application claims priority to Chinese patent application No. 201511032315.5, entitled “Method and Apparatus for Being Compatible with Forward Insertion and Inverted Insertion of Analog Earphone”, filed with Chinese Patent Office on Dec. 31, 2015, which is incorporated herein by reference in its entirety.

### TECHNICAL FIELD

The present disclosure relates to the field of electronics, and more specifically, to a method and an apparatus for being compatible with forward insertion and inverted insertion of an analog earphone.

### BACKGROUND

For a conventional USB interface, a front side needs to be distinguished from a back side, and access cannot be performed in case of inverted insertion. In this way, embarrassment that a USB is incorrectly inserted frequently occurs. In recent years, a USB TYPE C interface has been increasingly applied in a notebook computer and a mobile phone; the TYPE C interface supports forward insertion and inverted insertion, and people do not need to worry that a USB is inserted in a wrong direction.

The USB TYPE C not only solves the problem of forward insertion and inverted insertion, but also supports USB 3.0, and is also compatible with a conventional interface definition of USB 2.0, and further supports an analog audio interface on a conventional interface.

FIG. 1 is a schematic diagram of a definition of a TYPE C interface in the prior art. As shown in FIG. 1, compatibility with access of an analog earphone is implemented by sharing some interface pins: a left channel LEFT of the earphone shares with a USB DN; a right channel RIGHT of the earphone shares with a USB DP; a MIC shares with a GDN signal of the earphone in an either-or manner; and the sharing enables both of two sides of an interface to provide an entire set of input and output signals of the analog earphone, thereby implementing a function of access of the analog earphone by forward insertion and inverted insertion.

Specifically, the foregoing sharing implements selection of shared signals by adding an analog switch on a mainboard of a mobile phone or a computer. FIG. 2 is a schematic diagram of a shared circuit of being compatible with an analog earphone by a TYPE C interface in the prior art. As shown in FIG. 2, an existing TYPE C interface is respectively connected to a USB PHY (physical layer hardware) chip and a CODEC (encoder-decoder) chip so as to implement USB transmission and an audio function of an analog earphone respectively; two analog switches SW1 and SW2 are needed to implement pin sharing (wherein the SW1 controls switching of sharing of left and right channels L and R and two data lines D+ and D−; and the SW2 controls switching of either-or sharing of a MIC and a GND of the earphone). Loss of the switches themselves increases recording distortion, and affects recording quality. In addition, adding the two analog switches increases a board distribution area, and also increases costs; therefore, a supporting effect of being compatible with the analog earphone by the TYPE C interface in the prior art is unsatisfactory.

### SUMMARY

Embodiments of the present disclosure provide a method and an apparatus for being compatible with forward insertion and inverted insertion of an analog earphone, which can reduce system signal loss and lower costs.

The method for being compatible with forward insertion and inverted insertion of an analog earphone of an embodiment of the present disclosure includes:

Two differential input interfaces of the CODEC chip are connected to the SBU1 and SBU2 pins of the TYPE C interface respectively, wherein the SBU1 and SBU2 pins are the two sideband using signal pins and the two differential input interfaces are two MIC input interfaces of CODEC chip.

The apparatus for being compatible with forward insertion and inverted insertion of an analog earphone according to an embodiment of the present disclosure includes a USB TYPE C interface and a CODEC chip, wherein the two differential input interfaces of the CODEC chip are connected to the SBU1 and SBU2 pins of the TYPE C interface respectively, wherein the SBU1 and SBU2 pins are the two sideband using signal pins and the two differential input interfaces are two MIC input interfaces of CODEC chip.

By using the technical solutions provided by the embodiments of the present disclosure, when the TYPE C and the CODEC chip perform connection to implement an audio function of the earphone, the two differential input interfaces of the CODEC chip, namely the MIC input interfaces, are connected to sideband using signal pins of the USB TYPE C respectively, and selection of the MIC and GEN of the earphone can be completed by using the differential input interfaces of the CODEC chip. In this way, only one analog switch is needed to implement switching of sharing of left and right channels L and R and two data lines D+ and D−; as compared with two analog switches in the prior art, one analog switch is saved, so as to reduce loss of one switch; in addition, requirements for wiring space are greatly reduced, thereby saving costs.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic diagram of a definition of TYPE C interface in the prior art.

FIG. 2 is a schematic diagram of a shared circuit of being compatible with an analog earphone by a TYPE C interface in the prior art.

FIG. 3 is a schematic diagram of a connection between a CODEC chip and a TYPE C interface in an embodiment of the present disclosure.

FIG. 4 is a structural schematic diagram of an apparatus for being compatible with forward insertion and inverted insertion of an analog earphone in an embodiment of the present disclosure.

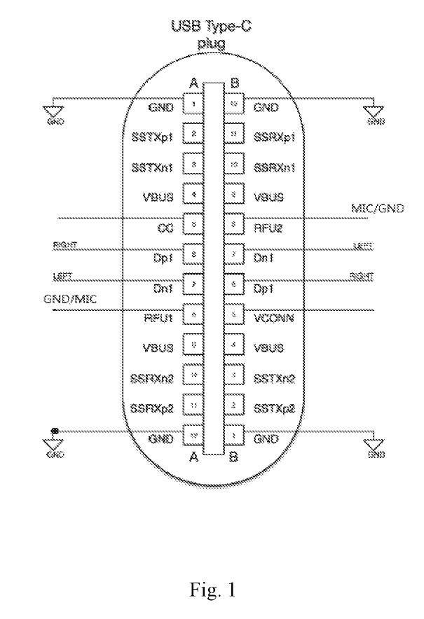

### DETAILED DESCRIPTION

The following exemplary embodiments of the present disclosure are described in a more detailed way with reference to the accompanying drawings. Although the accompanying drawings show exemplary embodiments of the present disclosure, it should be understood that the present disclosure can be implemented in various forms and should not be limited by embodiments set forth herein. Conversely, the embodiments are provided to understand the present disclosure more thoroughly, and may completely convey the scope of the present disclosure to a person skilled in the art.

According to the method for being compatible with forward insertion and inverted insertion of an analog earphone provided by an embodiment of the present disclosure, by using characters, of supporting differential inputs, of a CODEC chip, two differential input interfaces of the CODEC chip, namely MIC input interfaces, are led out to be connected to the SBU1 and SBU2 pins of the TYPE C interface respectively, so as to implement undifferentiated connection with the MIC signal and GND of the analog earphone, wherein the SBU1 and SBU2 pins are the two sideband using signal pins. By using the manner of this embodiment of the present disclosure, any differential input can be considered as the MIC signal or ground GND; in this way, signal input can be ensured no matter whether forward insertion or inverted insertion is performed on the analog earphone.

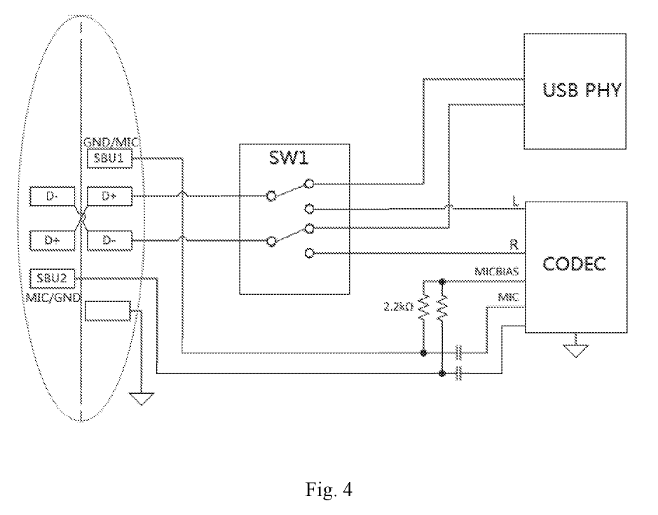

FIG. 3 is a schematic diagram of a connection between a CODEC chip and a TYPE C interface of an embodiment of the present disclosure. As shown in FIG. 3, two differentials of a CODEC chip are input to interfaces by two MIC inputs (MIC IN) of MIC− and MIC+ respectively. In this way, when a user inserts an analog earphone, no matter whether forward insertion or inverted insertion is performed (no matter whether MIC− is used as a MIC signal and MIC+ is used as ground; or MIC+ is used as ground and MIC− is used as a MIC signal), correctness of a signal obtained by the CODEC chip can be ensured.

In an embodiment of the present disclosure, preferably, two MIC inputs are further connected to a MIC bias voltage interface of a CODEC chip via a resistor respectively.

In an embodiment of the present disclosure, an objective of connecting MIC− and MIC+ interfaces of the CODEC chip to the MIC bias voltage interface of the CODEC chip via the resistor respectively is to perform voltage division for an external microphone.

In an embodiment of the present disclosure, a resistance value of MIC bias respectively with MIC− and MIC+ is 2.2K because resistance of external commonly used microphone is generally 2.2K. The partial pressure resistance value may change with variation of subsequent external microphone resistance.

In an embodiment of the present disclosure, MIC− and MIC+ signals are connected with MIC bias via a capacitor respectively. In an embodiment of the present disclosure, the capacitor is disposed in front of a partial pressure resistor.

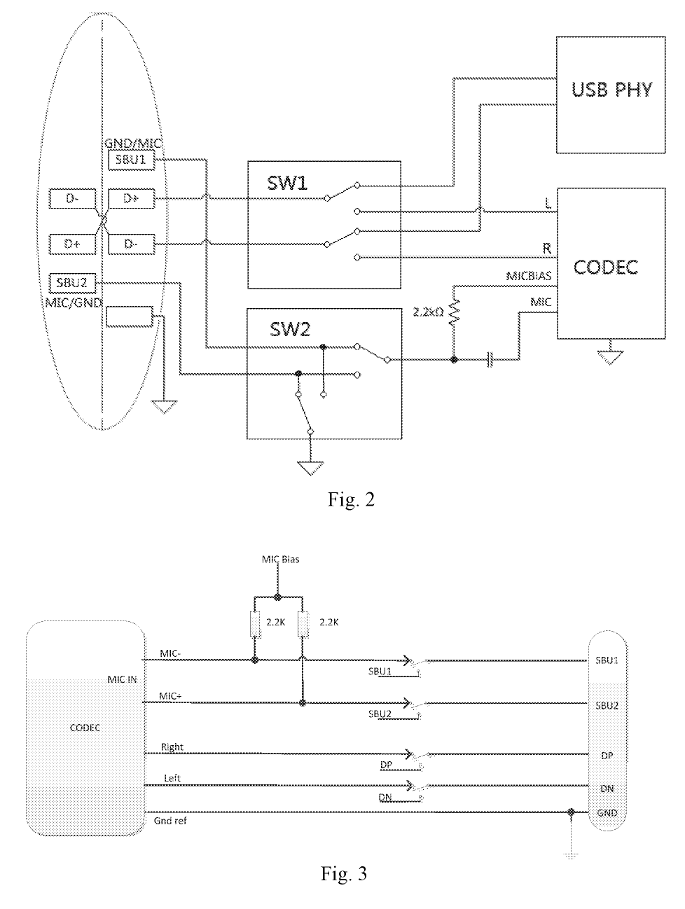

FIG. 4 is a structural schematic diagram of an apparatus for being compatible with forward insertion and inverted insertion of an analog earphone in an embodiment of the present disclosure. As shown in FIG. 4, an original analog switch SW2 of FIG. 2 is replaced by using a differential input circuit shown in FIG. 3.

By using technical scheme provided in the embodiments of the present disclosure, the analog switch SW2 in the prior art is omitted when selecting between MIC and earphone GND, so that only one analog switch is needed when making wire connection of the entire TYPE C. Compared with two analog switches in the prior art, one analog switch is saved, so as to reduce loss of one switch. Requirements for wiring space are greatly reduced, thereby saving costs.

The above mentioned is at least one embodiment of the present disclosure, without limiting the present disclosure. Any modification, equivalents, improvement and so on shall also fall in the protection scope of the present disclosure without departing from the spirit and principle of the present disclosure.

1-10. (canceled)

11. A method for being compatible with forward insertion and inverted insertion of an analog earphone, comprising:
two differential input interfaces of a CODEC chip are connected to the SBU1 and SBU2 pins of the TYPE C interface respectively, wherein the SBU1 and SBU2 pins are the two sideband using (SBU) signal pins and the two differential input interfaces are two MIC input interfaces of CODEC chip.

12. The method according to claim 11, further comprising:
the two MIC input interfaces are connected with the MIC bias voltage interface of the CODEC chip via partial pressure resistor respectively.

13. The method according to 12, wherein the partial pressure resistance value of the resistor is 2.2 kohm.

14. The method according to 12, further comprising:
the two MIC input interfaces are connected with the MIC bias voltage interface via a capacitor respectively.

15. The method according to 14, wherein the capacitors are disposed in front of the partial pressure resistors respectively.

16. An apparatus for being compatible with forward insertion and inverted insertion of an analog earphone, comprising a USB TYPE C interface and a CODEC chip, wherein
two differential input interfaces of the CODEC chip are connected to the SBU1 and SBU2 pins of the TYPE C interface respectively, wherein the SBU1 and SBU2 pins are the two sideband using (SBU) signal pins and the two differential input interfaces are two MIC input interfaces of CODEC chip.

17. The apparatus according to claim 16, wherein two MIC inputs of the CODEC chip are further connected to a MIC bias voltage interface of the CODEC chip via a partial pressure resistor respectively.

18. The apparatus according to claim 17, wherein the resistance value of the resistor is 2.2 kohm.

19. The apparatus according to claim 17, further comprising:
the two MIC input interfaces are connected to the MIC bias voltage interface via a capacitor respectively.

20. The apparatus according to claim 19, wherein the capacitors are disposed in front of the partial pressure resistors respectively.
